(19) United States
(12) Patent Application Publication
(10) Pub. No.: US 2023/0289853 A1
(43) Pub. Date: Sep. 14, 2023

(54) GENERATION AND MANAGEMENT OF PERSONALIZED METADATA

(71) Applicant: International Business Machines Corporation, Armonk, NY (US)

(72) Inventors: Anitha Tumu, Visakhapatnam (IN); Sri Harsha Varada, Vizianagaram (IN); Bhanu Dokkada, Hyderabad (IN); Saraswathi Sailaja Perumalla, Visakhapatnam (IN)

(21) Appl. No.: 17/654,698

(22) Filed: Mar. 14, 2022

(51) Int. Cl. G06Q 30/02; G06F 16/16

(52) U.S. Cl. CPC G06Q 30/0282; G06F 16/164

(57) ABSTRACT

In an approach to improve the management of personalized metadata embodiments generate, by a robotic tool, metadata associated with an event, match, by a natural language processor, user feedback to generated metadata, and generate a user data model based on the matched user feedback and generated metadata. Further, embodiments map the user data model against the event, or an item associated with the event, and group previous user reviews from secondary users with similar user preferences. Additionally, embodiments generate a trend of user preferences based on the user data model and the grouped user reviews from the secondary users, and output, by a display on a user interface, at least one user suggestion associated with the event based on the generated trend of user preferences.

### BACKGROUND OF THE INVENTION

The present invention relates generally to the field of data monitoring, and more particularly to personalized metadata management.

Metadata is data that provides information (e.g., details) about other data but not the content of the data, such as the text of a message or the image itself. There are many distinct types of metadata, comprising: descriptive metadata, structural metadata, administrative metadata, reference data, statistical metadata, and legal metadata. Descriptive metadata is the descriptive information about a resource. It is used for discovery and identification. It includes elements such as title, abstract, author, and keywords. Structural metadata is metadata regarding containers of data and indicates how compound objects are put together, for example, how pages are ordered to form chapters. It describes the types, versions, relationships and other characteristics of digital materials. Administrative metadata is the information used to help manage a resource, like resource type, permissions, and when and how it was created. Reference metadata is the information about the contents and quality of statistical data. Statistical metadata, also referred to as process data, may describe processes that collect, process, or produce statistical data. Legal metadata provides information about the creator, copyright holder, and public licensing, if provided. It should be noted that metadata is not strictly bounded to one of these categories, as it can describe a piece of data in many other ways.

Metadata management involves managing metadata about other data, whereby this “other data” is generally referred to as content data. Metadata management goes by the end-to-end process and governance framework for creating, controlling, enhancing, attributing, defining and managing a metadata schema, model or other structured aggregation system, either independently or within a repository and the associated supporting processes (often to enable the management of content). For web-based systems, URLs, images, video, and/or other media or data files or links may be referenced from a triples table of object, attribute, and value.

### SUMMARY

Embodiments of the present invention disclose a computer-implemented method, a computer program product, and a system for generating and managing personalized metadata management in real world applications, the computer-implemented method comprising: generating, by a robotic tool, metadata associated with an event; matching, by a natural language processor, user feedback to generated metadata; generating a user data model based on the matched user feedback and generated metadata; mapping the user data model against the event or an item associated with the event; grouping previous user reviews from secondary users with similar user preferences, wherein the similar user preferences are matching preferences within a predefined range or above a predetermined threshold; generating a trend of user preferences based on the user data model and the grouped user reviews from the secondary users; and outputting, by a display on a user interface, at least one user suggestion associated with the event based on the generated trend of user preferences.

### BRIEF DESCRIPTION OF THE DRAWINGS

FIG. 1A is a functional block diagram illustrating a distributed data processing environment, in accordance with an embodiment of the present invention;

FIG. 1B is a functional block diagram illustrating a distributed data processing environment of a metadata management component, in accordance with an embodiment of the present invention;

FIG. 2 illustrates operational steps of the metadata management component, on a server computer within the distributed data processing environment of FIGS. 1A-1B, for generating and managing personalized metadata, in accordance with an embodiment of the present invention; and

FIG. 3 depicts a block diagram of components of the server computer executing the metadata management component within the distributed data processing environment of FIGS. 1A-1B, in accordance with an embodiment of the present invention.

### DETAILED DESCRIPTION

Embodiments of the present invention recognize that, currently, food reviews in multiple portals are subjective, confusing, and misleading. For instance, a first food reviewer generates an online review stating that a restaurant's “burger is awesome” and then a second food reviewer generates an online review stating that a restaurant's stating that the same burger reviewed by the first food reviewer is “disgusting.” Embodiments of the present invention recognize that online reviews and in-particular food reviews a subject and thus are dependent on the reviewer's tastes, the cook/chef who prepared meal, and/or other subjective variables known and understood in the art. Embodiments of the present invention recognize that it is difficult for a user to obtain an accurate or accurate review from a second user (i.e., reviewer) who matches the first user's preferences (i.e., taste) and experience. An accurate review is a review that comprises a predetermined amount of data associated with a user's interest and/or is within a predetermined range of confidence. For example, first reviewer has a vegetarian or vegan diet/interest, and the second reviewer/user is vegetarian or vegan, then the feedback from the second reviewer is relevant/accurate to the first user.

Embodiments of the present invention improve the art of metadata management and solve the particular issue(s) stated above by: (i) executing and controlling a robotic tool that generates the metadata associated with a particular task or experience (e.g., the food eating experience for any given sample food by mimicking the human eating behaviors like following but not limited to chewing, gulping), (ii) converting user given feedback in natural language using known NLP techniques to match the metadata properties generated by the robotic tool, (iii) generating a model for the user with newly added feedback, (iv) generating and managing an experience code that comprises metadata of a particular experience and/or task, (v) retrieving and utilizing different generated models from different users to generate a trend of preferences of the user and suggesting improvements, (vi) grouping the user with similar or near similar preferences (e.g., taste and/or food type), and (vii) displaying user feedback based on the metadata and grouping of similar preferences (e.g., the reviews given by the similar users while ordering a particular food item from a particular restaurant).

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails and texts begin with a written notification that the user's information may be recorded or monitored and may be saved, for the purpose of generating, managing, and/or distributing personalized metadata. These embodiments may also include periodic reminders of such recording and monitoring throughout the course of any such use. Certain embodiments may also include regular (e.g., daily, weekly, monthly) reminders to the participating parties that they have consented to being recorded and monitored for generating, managing, and/or distributing personalized metadata, and may provide the participating parties with the opportunity to opt-out of such recording and monitoring if desired. Furthermore, to the extent that any non-participating parties' actions are monitored (for example, when outside vehicles are viewed), such monitoring takes place for the limited purpose of providing navigation assistance to a participating party, with protections in place to prevent the unauthorized use or disclosure of any data for which an individual might have a certain expectation of privacy.

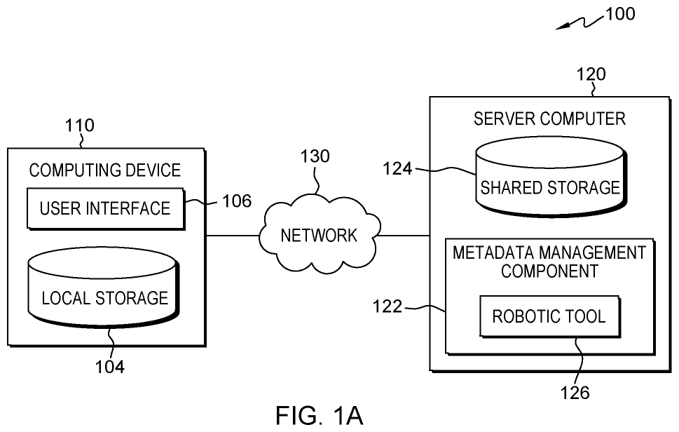

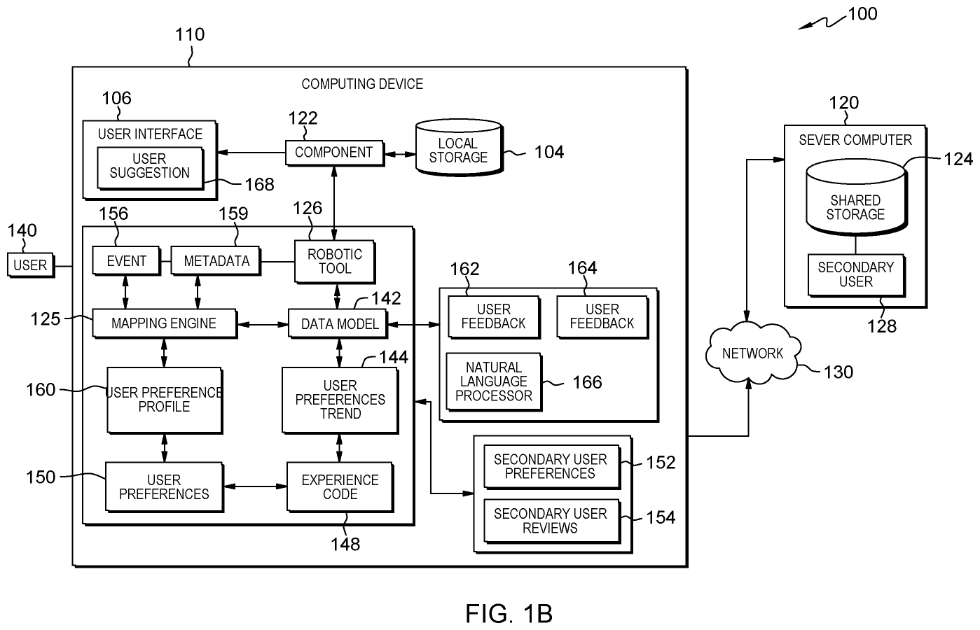

Implementation of embodiments of the invention may take a variety of forms, and exemplary implementation details are discussed subsequently with reference to the Figures (i.e., FIG. 1A-FIG. 3).

FIG. 1A is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1A provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes computing device 110 and server computer 120 interconnected over network 130.

Network 130 may be, for example, a storage area network (SAN), a telecommunications network, a local area network (LAN), a wide area network (WAN), such as the Internet, a wireless technology for exchanging data over short distances (using short-wavelength ultra-high frequency (UHF) radio waves in the industrial, scientific and medical (ISM) band from 2.4 to 2.485 GHz from fixed and mobile devices, and building personal area networks (PANs) or a combination of the three), and may include wired, wireless, or fiber optic connections. Network 130 may include one or more wired and/or wireless networks that may receive and transmit data, voice, and/or video signals, including multimedia signals that include voice, data, text and/or video data. In general, network 130 may be any combination of connections and protocols that will support communications between computing device 110 and server computer 120, and any other computing devices and/or storage devices (not shown in FIG. 1A) within distributed data processing environment 100.

In some embodiments of the present invention, computing device 110 may be, but is not limited to, a standalone device, a client, a server, a laptop computer, a tablet computer, a netbook computer, a personal computer (PC), a smart phone, a desktop computer, a smart television, a smart watch, a radio, a stereo system, a cloud based service (e.g., a cognitive cloud based service), AR glasses, a virtual reality headset, any HUD known in the art, and/or any programmable electronic computing device capable of communicating with various components and devices within distributed data processing environment 100, via network 130 or any combination therein. In general, computing device 110 may be representative of any programmable computing device or a combination of programmable computing devices capable of executing machine-readable program instructions and communicating with users of other computing devices via network 130 and/or capable of executing machine-readable program instructions and communicating with server computer 120. In some embodiments computing device 110 may represent a plurality of computing devices.

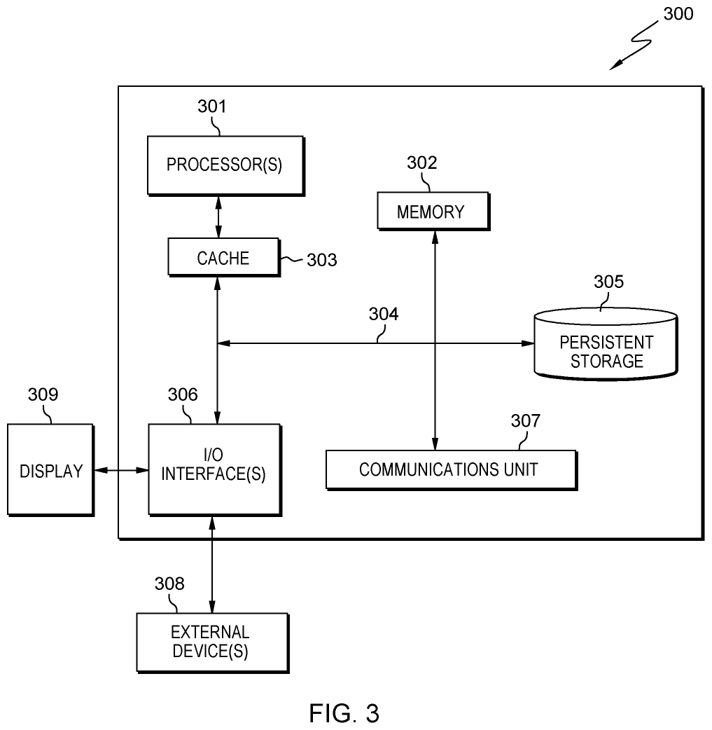

In some embodiments of the present invention, computing device 110 may represent any programmable electronic computing device or combination of programmable electronic computing devices capable of executing machine readable program instructions, manipulating executable machine-readable instructions, and communicating with server computer 120 and other computing devices (not shown) within distributed data processing environment 100 via a network, such as network 130. Computing device 110 may include an instance of user interface (interface) 106, and local storage 104. In various embodiments, not depicted in FIG. 1A, computing device 110 may have a plurality of interfaces 106. In other embodiments, not depicted in FIG. 1A, distributed data processing environment 100 may comprise a plurality of computing devices, plurality of server computers, and/or one a plurality of networks. Computing device 110 may include internal and external hardware components, as depicted, and described in further detail with respect to FIG. 3.

User interface (interface) 106 provides an interface to automatic traffic analysis (ATA) component (component) 122. Computing device 110, via user interface 106, may enable a user and/or a client to interact with component 122 and/or server computer 120 in various ways, such as sending program instructions, receiving program instructions, sending and/or receiving messages, updating data, sending data, inputting data, editing data, collecting data, and/or receiving data. In one embodiment, interface 106 may be a graphical user interface (GUI) or a web user interface (WUI) and may display at least text, documents, web browser windows, user options, application interfaces, and instructions for operation. interface 106 may include data (such as graphic, text, and sound) presented to a user and control sequences the user employs to control operations. In another embodiment, interface 106 may be a mobile application software providing an interface between a user of computing device 110 and server computer 120. Mobile application software, or an “app,” may be designed to run on smart phones, tablet computers and other computing devices. In an embodiment, interface 106 may enable the user of computing device 110 to at least send data, input data, edit data (annotations), collect data and/or receive data.

Server computer 120 may be a standalone computing device, a management server, a web server, a mobile computing device, one or more client servers, or any other electronic device or computing system capable of receiving, sending, and processing data. In other embodiments, server computer 120 may represent a server computing system utilizing multiple computers such as, but not limited to, a server system, such as in a cloud computing environment. In another embodiment, server computer 120 may represent a computing system utilizing clustered computers and components (e.g., database server computers, application server computers, etc.) that act as a single pool of seamless resources when accessed within distributed data processing environment 100. Server computer 120 may include internal and external hardware components, as depicted, and described in further detail with respect to FIG. 3. In some embodiments server computer 120 may represent a plurality of server computers.

Each of shared storage 124 and local storage 104 may be a data/knowledge repository and/or a database that may be written and/or read by one or a combination of component 122, server computer 120 and computing device 110. In some embodiments, each of shared storage 124 and local storage 104 may be a data/knowledge repository, a knowledge base, a knowledge center, a knowledge corpus, and/or a database that may be written and/or read by one or a combination of component 122, server computer 120 and computing device 110. In the depicted embodiment, shared storage 124 resides on server computer 120 and local storage 104 resides on computing device 110. In another embodiment, shared storage 124 and/or local storage 104 may reside elsewhere within distributed data processing environment 100, provided that each may access and is accessible by computing device 110 and server computer 120. Shared storage 124 and/or local storage 104 may each be implemented with any type of storage device capable of storing data and configuration files that may be accessed and utilized by server computer 120, such as, but not limited to, a database server, a hard disk drive, or a flash memory. In various embodiments, not depicted in FIG. 1A, in addition to shared storage 124, server computer comprises a primary and a secondary database, described below in FIG. 3. The primary database, also referred to as primary storage device, may be one or more of any type of disk storage known in the art. The secondary database, also referred to as secondary storage device, may be one or more any type of tape storage known in the art.

In the depicted embodiment, component 122 is executed on server computer 120. In other embodiments, component 122 may be executed on computing device 110. In various embodiments of the present invention, not depicted in FIG. 1A, component 122 may execute on a plurality of server computers 120 and/or on a plurality of computing devices 110. In some embodiments, component 122 may be located and/or executed anywhere within distributed data processing environment 100 as long as component 122 is connected to and/or communicates with, computing device 110, and/or server computer 120, via network 130.

In the depicted embodiments, component 122 comprises robotic tool 126; however, robotic tool 126 may be located and/or executed anywhere within distributed data processing environment 100 as long as component robotic tool 126 is connected to and/or communicates with, component 122, computing device 110, and/or server computer 120, via network 130. Robotic tool may be a video capturing device, microphone, robotic appendage (e.g., finger, arm, hand, foot, or leg) wherein the robotic appendage can record and store data (e.g., metadata), a robotic instrument that can mimic human food consumption (e.g., chewing, tasting, and gulping), and/or any other robotic tool that is known and understood in the art. In some embodiments, the robotic tool comprises artificial saliva.

In various embodiments, via Robotic tool 126, generates metadata associated with a particular task, event, item and/or experience (e.g., the food eating experience for any given sample food by mimicking the human eating behaviors like following but not limited to chewing, gulping). The terms task, event, item and/or experience may be represented by the term “event,” wherein the term event encompasses the meaning of the terms task, event, item and/or experience (e.g., eating, exercising, shopping, viewing entertainment, attending events like sports games, concerts, or business meetings, and/or anything known and understood in the art). In one particular example, robotic tool 126 comprises artificial saliva which can be used to mimic the user eating behavior, wherein robotic tool 126 generates artificial saliva and analyzes various food items to predict or estimate food choices as user food preferences information. In other embodiments, personalized metadata could be extended for other aspects where user experience/feedback is relevant such as travel experience, entertainment, and/or any other user experiences known and understood in the art. In this example, artificial saliva is used to mimic eating and chewing behavior of a user. In another embodiment, robotic tool 126 may mimic, via various video capturing technology, a user's visual site, wherein component 122 uses the collected visual information to predict seating preferences at a venue based on current user preferences and secondary user reviews. Component 122 may create a user preference profile based on learned or submitted user preferences and/or habits. For example, learned eating habits and preferences or learned viewing and seating preferences of the user.

Further, in various embodiments, component 122 converts user given feedback into natural language using known NLP techniques to match the metadata properties generated by the robotic tool. Component 122 may generate a model for the user with newly added user feedback and previously presented/stored user feedback, wherein the generated model matures as it receives and/or retrieves user feedback and/or preferences from component 122, shared storage 124, local storage 104, and directly from the user via interface 106. The generated model may be a personalized model that is tailored around the preferences of the user. In various embodiments the generated model may be a design model, wherein abstraction that represents and communicate data associated with the user's predetermined and/or custom preferences (e.g., preferences associated with an eating/dining experience). Additionally, component 122 may generate and manage an experience code that comprises metadata of a particular experience, event, and/or task. For example, component 122 generates links to a food menu card and generates a unique food experience code that is associated with a particular user. Component 122 may generate and/or retrieve metadata associated with items on the menu from the user or previous secondary users, wherein the unique experience code may store metadata generated and/or retrieved by component 122. In the food menu example, component may generate or retrieve metadata associated with the food availability, type of food, ingredients used, nutrition facts, food preparation day (e.g., freshness of the food items), location of the venue.

In various embodiments, component 122 may retrieve previous feedback from a secondary user and extract metadata from the retrieved feedback. In some embodiments, component 122, via NPL, extracts user preference data from the retrieved feedback and uses the extracted metadata, user preference data, retrieved metadata, and/or generated metadata to map the generated model against an item, event, or experience. For example, mapping the generated model against items in the menu card. In various embodiments, component 122 generates and outputs suggestions to the user based on the mapped data, wherein the suggestions are items, experiences, and/or events that user may prefer or has preferred previously. For example, food items that the user would prefer or has preferred previously. In various embodiments, component 122 may generate and output, via interface 106, a weighted list of suggestions associated with an event to the user, wherein the weighted suggestions are weighted based on a predetermined weighing system.

In various embodiments, component 122 may retrieve and utilize different generated models from different users (i.e., secondary users) to generate a trend of preferences of the user. Component 122 may retrieve stored generated models from secondary users and/or the current user to generate user preference trends and/or to generate item, event, or experience suggestions. Further, in various embodiments, component 122 suggesting improvements to a host and/or venue based on the generated user preference trend(s). For example, generating and submitting feedback to restaurants website (e.g., online review). In various embodiments, component 122 group, using the known clustering techniques, the user with secondary users with similar or near similar preferences (e.g., taste and/or food type). Component 122 may enhance the generated suggestions to the user by retrieving and displaying the reviews generated by the secondary user to the current user (i.e., primary user). In various embodiments, component 122 display, via interface 106, user feedback based on the metadata and grouping of similar preferences (e.g., the reviews given by the similar/grouped users while ordering a particular food item from a particular restaurant).

For example, a robotic chewing machine (i.e., robotic tool 126) that chews and analyzes given sample foods, and generates the metadata associated with food experience. In this example, metadata comprises crunchiness, softness, sweetness, saltiness, bitterness, temperature, taste after chewing, before chewing, and cool ness after gulping. A user may eat the same sample food and provide user feedback (e.g., user rating, preferences, thoughts, and review) which can be stored on a public/personal cloud (e.g., shared storage 124) as user preferences or user feedback. Further, a user review can be in a plain text language saying (e.g., “I enjoyed the crispiness of this food. It would be better if it was less spicy”). In this example, using NLP, component 122 maps the user feedback with the metadata generated by the robotic machine.

Component 122 will capture different user experiences during and after the meal and store the captured user experiences on shared storage 124. Additionally, component 122 will generate a personalized model for the user as in what user likes and what user don't include the weather, climatic, health conditions based on the matched user feedback and generated metadata. In this particular example, any new food that the user is about to consume will be fed to robotic tool 126, wherein the robotic tool 126 compares the food experience with the personalized model of the user, wherein component 122 suggests the probability of user liking the given food. As a business model any hotel/food delivery vendors can own the machine, where they will feed the samples to that machine and the respective metadata will be available in cloud, wherein if a user wants to order the food, he/she can pick those food items which matches their personal interest.

Further, component 122 solves the particular issues stated above and improves the art by (i) generating, by robotic tool 126, metadata associated with an event, (ii) matching, by a natural language processor, user feedback to the generated metadata; (iii) generating a user data model based on the matched user feedback and generated metadata; (iv) mapping the user data model against the event or an item associated with the event; (v) grouping previous user reviews from secondary users with similar user preferences, wherein similar user preferences are matching preferences within a predefined range or above a predetermined threshold; (vi) generating a trend of user preferences based on the user data model and the grouped user reviews from the secondary users, and (vii) outputting, by a display on a user interface, at least one user suggestion associated with the event based on the generated trend of user preferences.

FIG. 1B is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1B provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes user 140, computing device 110, and server computer 120 interconnected over network 130.

In the depicted embodiment, component 122, via robotic tool 126, generates metadata 159 associated with event 156 (e.g., the food eating experience for any given sample food by mimicking the human eating behaviors like following but not limited to chewing, gulping). The terms task, event, item and/or experience may be represented by the term “event,” wherein the term event encompasses the meaning of the terms task, event, item and/or experience (e.g., eating, exercising, shopping, viewing entertainment, attending events like sports games, concerts, or business meetings, and/or anything known and understood in the art). In one particular example, robotic tool 126 comprises artificial saliva which can be used to mimic the user eating behavior, wherein robotic tool 126 generates artificial saliva and analyzes various food items to predict or estimate food choices as user food preferences information. In this example, artificial saliva is used to mimic eating and chewing behavior of a user. In another embodiment, robotic tool 126 may mimic, via various video capturing technology, a user's visual site, wherein component 122 uses the collected visual information to predict seating preferences at a venue based on current user preferences and secondary user reviews.

In the depicted embodiment, component 122 creates user preference profile 160 based on learned or submitted user preferences and/or habits (user preferences) 150. For example, learned eating habits and preferences or learned viewing and seating preferences of the user. Further, in the depicted embodiments, component 122 converts user given feedback (user feedback 162) into natural language using known NLP techniques to match the metadata 159 generated by robotic tool 126. Component 122 generates data model 142 based on user feedback 162 and previously presented/stored user feedback (i.e., secondary user feedback 164), wherein data model 142 matures as it receives and/or retrieves user feedback 162 and/or user preferences 150 from component 122, shared storage 124, local storage 104, and directly from the user via interface 106. Data model 142 may be a personalized model that is tailored around user preference 150. Additionally, component 122 generates and manages an experience code 148 that comprises metadata of event 156. For example, component 122 generates links to a food menu card and generates a unique food experience code that is associated with a particular user. In the depicted embodiment, component 122 generates and/or retrieves metadata 159 associated with event 156 from user 140 or secondary user 128, wherein unique experience code 148 may store metadata generated and/or retrieved by component 122. In the food menu example, component 122 may generate or retrieve metadata associated with the food availability, type of food, ingredients used, nutrition facts, food preparation day (e.g., freshness of the food items), location of the venue.

Further, in the depicted embodiment, component 122 retrieve previous feedback from a secondary user (secondary user feedback 164) and extract metadata from the retrieved feedback. Component 122, via NPL 166, extracts user preference data from the retrieved feedback and uses the extracted metadata, user preference data, retrieved metadata, and/or generated metadata to map, via mapping engine 125, data model 142 against an item, event, or experience. For example, mapping data model 142 against items in the menu card. Component 122 generates and outputs user suggestions 168 to the user based on the mapped data, wherein the suggestions are items, experiences, and/or events that user may prefer or has preferred previously. For example, food items that the user would prefer or has preferred previously. In various embodiments, component 122 may generate and output, via interface 106, a weighted list of suggestions, wherein the weighted suggestions are weighted based on a predetermined weighing system. In some embodiments, component 122 may generate and output predetermined user reviews to an online review site associated with event 156, wherein the predetermined user review is responsive to user 140 accepting the submission, via interface 106, and online posting of the generated user review.

In the depicted embodiment, component 122 may retrieve and utilize different generated models from different users (i.e., secondary users 128) to generate a trend of preferences of the user (user preferences trend 144). Component 122 retrieves stored generated models from secondary user 128 and/or user 140 to generate user preferences trend 144 and/or to generate item, event, or experience suggestions (i.e., user suggestion 168). Further, in various embodiments, component 122 suggesting improvements to a host and/or venue based on the generated user preference trend(s). For example, generating and submitting feedback to restaurants website (e.g., online review). In the depicted embodiment, component 122 groups, using the known clustering techniques, user 140 with secondary users 128 with secondary user preferences 152 similar user preferences 150. Component 122 may enhance the generated suggestions to the user by retrieving and displaying secondary user reviews 154 to user 140. In various embodiments, component 122 display, via interface 106, user feedback 162 based on the metadata and grouping of similar preferences (e.g., the reviews given by the similar/grouped users while ordering a particular food item from a particular restaurant).

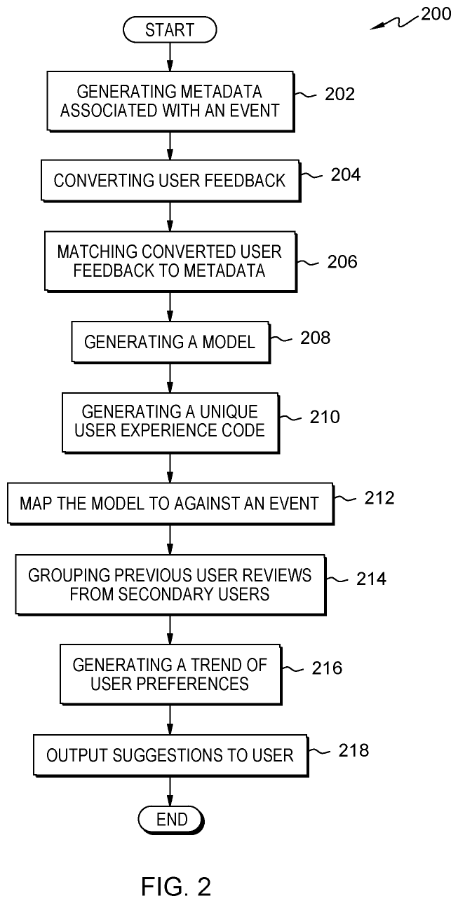

FIG. 2 illustrates operational steps of component 122, generally designated 200, in communication with server computer 120, within distributed data processing environment 100 of FIG. 1A and/or FIG. 1B, for generating and managing personalized metadata associated with an event, in accordance with an embodiment of the present invention. FIG. 2 provides an illustration of one implementation and does not imply any limitations with regard to the environments in which different embodiments may be implemented. Many modifications to the depicted environment may be made by those skilled in the art without departing from the scope of the invention as recited by the claims.

In step 202, component 122 generates metadata associated with an event. In various embodiments, component 12 generates, via robotic tool 126, metadata associated with one or more events based on a user request. In various embodiments, component 122 collects and/or retrieves metadata associated with an event. In various embodiments, component 122 generates metadata associated with an event, wherein the metadata can be used for computing and decoding purpose. For example:

```
<metric>
  <spicy>43</spicy>
  <crunchy>26</crunchy>
  <hot>10</hot>
  <reviewscore>Above Average</reviewscore>
</metric>.
```

In step 204, component 122 converts user feedback into natural language. In various embodiments, component 122 converts user provided feedback either current or historic (e.g., previously stored on local storage 104 and/or shared storage 124).

In step 206, component 122 matches the converted user feedback to the generated metadata. In various embodiments, component 122 matches the converted user feedback to the metadata properties generated by robotic tool 126. For example, robotic tool 126 comprises an electronic tongue that is able to tastes and categorize food. In this example, component 122, via robotic tool 126, generates a metadata score as mentioned in step 202 associated with the ingested/analyzed food. The user feedback score may be generated based on historical eating patterns. The calculated/output robotic tool scores may be compared to identify if a particular dish matches with user preference.

In step 208, component 122 generates a data model. In various embodiments, component 122 generates a data model based on the matched user feedback and generated metadata. Component 122 may generate a model for the user with newly added user feedback and previously presented/stored user feedback, wherein the generated model matures as it receives and/or retrieves user feedback and/or preferences from component 122, shared storage 124, local storage 104, and directly from the user via interface 106. The generated model may be a personalized model that is tailored around the preferences of the user.

In step 210, component 122 generates a unique user experience code. In various embodiments, component 122 generates a unique user experience code that is associated with an event, wherein the unique user experience code comprises metadata associated with the event.

In step 212, component 122 maps the model against the event. In various embodiments, component 122, via a mapping engine, maps the generated data model against the event.

In step 214, component 122 groups previous user reviews from secondary users. In various embodiments, component 122 groups one or more previous user reviews from one or more secondary users stored on local storage 104 and/or shared storage 124.

In step 216, component 122 generates a trend of user preferences. In various embodiments, component 122 generates a trend of user preferences based on the user data model and the grouped user reviews from the secondary users.

In step 218, component 122 outputs a suggestion to the user. In various embodiments, component 122 outputs, by a display on interface 106, at least one user suggestion associated with the event based on the generated trend of user preferences. In some embodiments, the suggestion can be a predetermined user review. In various embodiments, the output suggestions are responsive display prompts that query the user to select one or more predetermined responses, and/or prompt the user to input custom feedback, via interface 106.

FIG. 3 depicts computer system 300, where server computing 120 represents an example of computer system 300 that includes component 122. The computer system includes processors 301, cache 303, memory 302, persistent storage 305, communications unit 307, input/output (I/O) interface(s) 306, display 309, external device(s) 308 and communications fabric 304. Communications fabric 304 provides communications between cache 303, memory 302, persistent storage 305, communications unit 307, and input/output (I/O) interface(s) 306. Communications fabric 304 may be implemented with any architecture designed for passing data and/or control information between processors (such as microprocessors, communications, and network processors, etc.), system memory, peripheral devices, and any other hardware components within a system. For example, communications fabric 304 may be implemented with one or more buses or a crossbar switch.

Memory 302 and persistent storage 305 are computer readable storage media. In this embodiment, memory 302 includes random access memory (RAM). In general, memory 302 may include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 may include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 enables for input and output of data with other devices that may be connected to each computer system. For example, I/O interface 306 may provide a connection to external devices 308 such as a keyboard, keypad, a touch screen, and/or some other suitable input device. External devices 308 may also include portable computer readable storage media such as, for example, thumb drives, portable optical or magnetic disks, and memory cards. Software and data used to practice embodiments of the present invention may be stored on such portable computer readable storage media and may be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium may be any tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for generating and managing personalized metadata associated with an event, the computer-implemented method comprising:
generating, by a robotic tool, metadata associated with an event;
matching, by a natural language processor, user feedback to the generated metadata;
generating a user data model based on the matched user feedback and generated metadata;
mapping the user data model against the event or an item associated with the event;
grouping previous user reviews from secondary users with similar user preferences, wherein the similar user preferences are matching preferences within a predefined range or above a predetermined threshold;
generating a trend of user preferences based on the user data model and the grouped user reviews from the secondary users; and
outputting, by a display on a user interface, at least one user suggestion associated with the event based on the generated trend of user preferences.

2. The computer-implemented method of claim 1, further comprising:
converting historic or current user feedback; and
generating a unique user experience code that is associated with the event, wherein the unique user experience code comprises the metadata associated with the event.

3. The robotic tool of claim 1, wherein the robotic tool comprises artificial saliva, wherein the artificial saliva is used to mimic a first user's eating behavior or eating preferences in a user profile.

4. The computer-implemented method of claim 1, further comprising:
grouping a first user and the secondary users based on the user preferences that are within a predetermined range of similarity; and
providing the reviews given by the secondary users with similar preferences while engaging in the event the first user is currently engaging in.

5. The computer-implemented method of claim 1, wherein the at least one suggestion is a responsive display prompt that queries the first user to select one or more predetermined responses or prompts the first user to input custom feedback.

6. The computer-implemented method of claim 1, further comprising:
retrieving stored generated models from the secondary users and a first user to generate user preference trends and generate suggestions for the event.

7. The computer-implemented method of claim 1, further comprising:
generating a weighted list of suggestions associated with an event to the first user; and
outputting, by the user interface, a weighted list of suggestions associated with an event to the first user, wherein the weighted list of suggestions are weighted based on a predetermined weighing system.

8. A computer system for generating and managing personalized metadata associated with an event, the computer system comprising:
one or more computer processors;
one or more computer readable storage devices;
program instructions stored on the one or more computer readable storage devices for execution by at least one of the one or more computer processors, the stored program instructions comprising:
program instructions to generate, by a robotic tool, metadata associated with an event;
program instructions to match, by a natural language processor, user feedback to the generated metadata;
program instructions to generate a user data model based on the matched user feedback and generated metadata;
program instructions to map the user data model against the event or an item associated with the event;
program instructions to group previous user reviews from secondary users with similar user preferences, wherein the similar user preferences are matching preferences within a predefined range or above a predetermined threshold;
program instructions to generate a trend of user preferences based on the user data model and the grouped user reviews from the secondary users; and
program instructions to output, by a display on a user interface, at least one user suggestion associated with the event based on the generated trend of user preferences.

9. The computer system of claim 8, further comprising:
program instructions to convert historic or current user feedback; and
program instructions to generate a unique user experience code that is associated with the event, wherein the unique user experience code comprises the metadata associated with the event.

10. The computer system of claim 8, wherein the robotic tool comprises artificial saliva, wherein the artificial saliva is used to mimic a first user's eating behavior or eating preferences in a user profile.

11. The computer system of claim 8, further comprising:
program instructions to group a first user and the secondary users based on the user preferences that are within a predetermined range of similarity; and
program instructions to provide the reviews given by the secondary users with similar preferences while engaging in the event the first user is currently engaging in.

12. The computer system of claim 8, wherein the at least one suggestion is a responsive display prompt that queries the first user to select one or more predetermined responses or prompts the first user to input custom feedback.

13. The computer system of claim 8, further comprising:
program instructions to retrieve stored generated models from the secondary users and a first user to generate user preference trends and generate suggestions for the event.

14. The computer system of claim 8, further comprising:
program instructions to generate a weighted list of suggestions associated with an event to the first user; and
outputting, by the user interface, a weighted list of suggestions associated with an event to the first user, wherein the weighted list of suggestions are weighted based on a predetermined weighing system.

15. A computer program product for generating and managing personalized metadata associated with an event, the computer program product comprising:
one or more computer readable storage devices and program instructions stored on the one or more computer readable storage devices, the stored program instructions comprising:
program instructions to generate, by a robotic tool, metadata associated with an event;
program instructions to match, by a natural language processor, user feedback to the generated metadata;
program instructions to generate a user data model based on the matched user feedback and generated metadata;
program instructions to map the user data model against the event or an item associated with the event;
program instructions to group previous user reviews from secondary users with similar user preferences, wherein the similar user preferences are matching preferences within a predefined range or above a predetermined threshold;
program instructions to generate a trend of user preferences based on the user data model and the grouped user reviews from the secondary users; and
program instructions to output, by a display on a user interface, at least one user suggestion associated with the event based on the generated trend of user preferences.

16. The computer program product of claim 15, further comprising:
program instructions to convert historic or current user feedback; and
program instructions to generate a unique user experience code that is associated with the event, wherein the unique user experience code comprises the metadata associated with the event.

17. The computer program product of claim 15, wherein the robotic tool comprises artificial saliva, wherein the artificial saliva is used to mimic a first user's eating behavior or eating preferences in a user profile.

18. The computer program product of claim 15, further comprising:
program instructions to group a first user and the secondary users based on the user preferences that are within a predetermined range of similarity; and
program instructions to provide the reviews given by the secondary users with similar preferences while engaging in the event the first user is currently engaging in.

19. The computer program product of claim 15, further comprising:
program instructions to retrieve stored generated models from the secondary users and a first user to generate user preference trends and generate suggestions for the event.

20. The computer program product of claim 15, further comprising:
program instructions to generate a weighted list of suggestions associated with an event to the first user; and
outputting, by the user interface, a weighted list of suggestions associated with an event to the first user, wherein the weighted list of suggestions are weighted based on a predetermined weighing system.
